(19) United States
(12) Patent Application Publication
(10) Pub. No.: US 2022/0351306 A1
(43) Pub. Date: Nov. 3, 2022

(54) SYSTEMS AND METHODS FOR EQUIPMENT TRACKING AND OPERATIONS VIA DIGITAL DISTRIBUTED LEDGERS

(71) Applicant: CNH Industrial America, LLC, New Holland, PA (US)

(72) Inventors: Robert A. Zemenchik, Fair Oaks, CA (US); Ravi Tolani, Oak Brook, IL (US)

(21) Appl. No.: 17/243,301

(22) Filed: Apr. 28, 2021

(51) Int. Cl. G06Q 50/02; G06F 16/27; G06F 21/60; G06F 21/31

(52) U.S. Cl. CPC G06Q 50/02; G06F 16/27; G06F 21/602; G06F 21/31; G06Q 2220/10

(57) ABSTRACT

Techniques are described that include creating and retrieving equipment information via a digital distributed ledger-based system. The techniques include authenticating a user of a digital distributed ledger-based system. The techniques further include receiving an operations data from the user, wherein the operations data comprises equipment data logged during operations of an equipment. The techniques additionally include storing the operations data and identification information for the equipment in at least one or more blocks of a digital distributed ledger, and distributing the one or more blocks among nodes of the digital distributed ledger, wherein the digital distributed ledger is configured to immutably store the operations data.

### BACKGROUND

The present disclosure relates generally to equipment tracking and operations, and more particularly to systems and methods for equipment tracking and operations via digital distributed ledgers.

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Various entities, including operators of equipment (e.g., farming equipment) may engage in various operations (e.g., planting, harvesting) that may be logged, for example, for subsequent reporting. For example, an agricultural vehicle may tow a seeder/planter to create a trench in the soil, deposit seeds, and fill the trench. Likewise, a harvesting vehicle may reap thresh, and/or winnow a crop during harvesting operations. It would be beneficial to improve equipment operations and/or reporting.

### BRIEF DESCRIPTION

The techniques described herein are generally directed at creating and/or using a digital distributed ledger-based system (e.g., blockchain-based system) to improve operations, reporting, and/or analysis of equipment. While the techniques described herein use farming equipment as an example, equipment may include industrial equipment, mining equipment, power generation equipment, automotive equipment, and so on. The digital distributed ledger may provide an immutable data repository that may then be leveraged for equipment verification, logging of operations, financial recordkeeping, data analysis of operation, maintenance, authentication, and the like. For example, operations of equipment (e.g., farming equipment) may produce data logs that may be now stored in the digital distributed ledger and that may be authenticated as being produced by a specific equipment, at a given time and date. Likewise, an equipment service provider, such as an equipment maintainer, may now enter information into the digital distributed ledger, including parts maintained/replaced, type of maintenance work done, cost of maintenance, and so on, and verify that the work was done by entering their authentication information. Other participants in the digital distributed ledger-based system include equipment manufacturers, equipment operators, data analysts, financial entities, governmental agencies, regulatory agencies, and the like, which may be authenticated to participate in an authenticated and validated ecosystem provided via the digital distributed ledger, as further described below.

A digital distributed ledger, such as a blockchain, may thus be used to provide an immutable or otherwise unchangeable record of certain operations, logs, documents, reports, analysis, transactions, and so on, related to equipment associated with the digital distributed ledger. The digital distributed ledger-based system may further provide for crypto security features and for records that may be verified to provide for enhanced security and trust. Additionally, certain ledger entries may be automatically stored, signed and updated through blockchain techniques, eliminating middlemen and providing for enhanced transactional efficiencies.

It is appreciated that implementations in accordance with the present disclosure can include any combination of the aspects and features described herein. That is, implementations in accordance with the present disclosure are not limited to the combinations of aspects and features specifically described herein, but also include any other appropriate combinations of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an embodiment of a system for equipment trail creation and management, according to aspects of the present disclosure;

FIG. 2 illustrates a block diagram of an embodiment of a blockchain, according to aspects of the present disclosure;

FIG. 3 is a flowchart depicting an embodiment of a process for the creation, storage, and querying of certain equipment data to be stored as blockchain trails, according to aspects of the present disclosure;

FIG. 4 depicts an example computing system, according to aspects of the present disclosure; and

FIG. 5 is a flowchart illustrating an embodiment of a process for providing verifiable transactions in a distributed ledger, according to aspects of the present disclosure.

### DETAILED DESCRIPTION

Embodiments of the present disclosure may include systems, devices, methods, and computer-readable media for creating, maintaining, and updating equipment and equipment-related entities (e.g., manufacturer, owner, operator, service provider, data analyst, financial entity, governmental agency, regulatory agency, etc.) interaction information, authentication information, and the like, via digital distributed ledgers. In some embodiments, one or more digital ledgers may be implemented to include equipment “trails” and entity “trails.” In use, information may be tagged as belonging to a specific equipment (e.g., a tractor that may be identified by vehicle identification number (VIN)), equipment type, equipment manufacturer, equipment owner, equipment service provider, data analyst, and the like, and stored in a digital distributed ledger via the trails. The trail information may be linked, thus providing for a chain or trail for a given equipment. For example, a physical description of the equipment may be linked to manufacturing information describing when, where, by whom, and by what process (e.g., additive manufacturing, milling, assembly processes, etc.) equipment and equipment parts have been manufactured. During equipment operations, e.g., farming operations, log data such as seed type, seed deposition rates, soil type, soil humidity, soil pH, soil temperature, weather data (e.g., humidity, air temperature, wind speed, wind direction, solar radiation, sun exposure), vehicle speed, vehicle direction, vehicle position (e.g., latitude, longitude), vehicle orientation (e.g., driving forward, driving backward), and so on, may be stored in the digital distributed ledger.

Likewise, harvesting records may be logged via the digital distributed ledger, such as equipment used (e.g., type of harvester and/or related equipment such as a towed harvesting system), type of crop, harvest rates, yields, harvester speed, harvester direction, harvester position (e.g., latitude, longitude), harvester orientation (e.g., driving forward, driving backward), and so on. Various entities may use the digital distributed ledger, including service operators, equipment owners, manufacturers, data analysts, and so on. Each entity may be authenticated, for example, via public/private key techniques further described below, to participate in the distribute ledger-based system described herein. Service operators, such as a mechanic, may inspect the equipment, service the equipment and log the maintenance performed via the digital distributed ledger-based system. Owners of equipment may use the digital distributed ledger to store ownership records, as well as to verify that certain events have occurred, such as scheduled maintenance, updates to equipment manuals, and so on. Operators of the equipment may similarly use the digital distributed ledger to verify equipment maintenance, equipment conditions, to log operation records (e.g., planting operations, harvesting operations), to read current equipment operation manuals, to view field instructions (e.g., instructions on how to traverse a given field during planting and/or harvesting), and so on.

Data analysts may now use authenticated data to better analyze field yields, to analyze crop production and the like, based on how planting operations were performed, which seeds were used, type of soil used, meteorological data, and so on. Financial entities may also participate in the digital distributed ledger-based system, for example to verify ownership records, perform loan analysis, provide loan information, store payment received, and so on. The information described herein may be stored in trails to be tracked using the digital distributed ledger-based system, such as a system that includes one or more blockchains. The blockchain(s) provide immutable and secure data storage, which may be distributed across a plurality of computing systems or nodes. As new information is generated (e.g., new equipment operations logs, field information, maintenance information, financial information, and so on), the new information may be included in the digital distributed ledger-based system, thus “growing” the trails throughout the lifetime of the equipment being tracked. The digital distributed ledger system, which may include one or more blockchains, may be used to store the information, including new information, more efficiently, securely, and robustly. The digital distributed ledger-based system may also provide enhanced security, such that only authorized individuals and/or processes can access cryptographically protected data on the digital distributed ledger-based system. The digital distributed ledger-based system may also provide for immutability, such that data records written to the digital distributed ledger may not be changed or removed once written.

The blockchain may grow as new blocks are added based on a new set of information. In some examples, a single block may be derived from multiple information, e.g., from a operations log and associated information (e.g., sensor data, field condition records, meteorological records) that were collected during operations. In general, blocks are added to the blockchain in a linear, chronological order by one or more computing devices in a peer-to-peer network of interconnected computing devices that execute a blockchain protocol. The peer-to-peer network may be described as a plurality of interconnected nodes, each node being a computing device that uses a client to validate and to relay transactions to other nodes. Each node may maintain a copy of the blockchain, which is automatically downloaded to the node upon joining the peer-to-peer network. The blockchain protocol may provide for a secure and reliable method of updating the blockchain, copies of which are distributed across the peer-to-peer network, without use of a central authority. Blocks and/or information included in the blocks may be encrypted, thus providing for increased security.

As described in further detail below, a ledger of trails may be used based on the amount of work (e.g., computing work such as hashing) required to add a transaction to the ledger (e.g., add a block to the blockchain). Blockchains may also employ other protocols, for example, that may define “work” differently. The work may be a computing task that may be difficult for any single node (e.g., computing device) in the peer-to-peer network to complete quickly based on the size of the digital distributed ledger, but may be relatively easy for any node (e.g., computing device) to verify.

The peer-to-peer network may include multiple “miners” (e.g., computing devices) that add blocks to a blockchain based on the blockchain protocol. In general, multiple miners validate transactions that are to be added to a block, and compete (e.g., perform computing work, as introduced above) to have their respective block added to the blockchain. Validation of transactions includes verifying digital signatures associated with respective transactions. For a block to be added to the blockchain, a miner must demonstrate a proof of work before their proposed block of transactions is accepted by the peer-to-peer network, and before the block is added to the blockchain. In certain embodiments, a blockchain protocol include a proof of work scheme that is based on a cryptographic hash function (CHF). An example CHF includes the secure hash algorithm 256 (SHA-256). In general, the CHF receives information as input, and provides a hash value as output, the hash value being of a predetermined length. For example, SHA-256 outputs a 256-bit (32-byte, 64-character) hash value. In some examples, the hash value is a one-way hash value such that the output hash value cannot be ‘un-hashed’ to determine what the input was. The blockchain protocol can require multiple pieces of information as input to the CHF. For example, the input to the CHF can include a reference to the previous (most recent) block in the blockchain, details of the transaction(s) that are to be included in the to be created block, and a “nonce” value (e.g., a random number used only once).

Multiple nodes may compete to hash a set of transactions and to provide the next block that is to be added to the blockchain. The blockchain protocol provides a threshold hash to qualify a block to be added to the blockchain. For example, the threshold hash can include a predefined number of zeros (0's) that the hash value must have at the beginning (e.g., at least the first four characters of the hash value must each be zero). The higher the number of zeros, the more computationally time-consuming it may be to arrive at a qualifying hash value.

In accordance with the blockchain protocol, each miner in the peer-to-peer network receives transaction information for one or more transactions that are to be included in a block that is to be added next in the blockchain. Each miner provides the reference to the previous (most recent) block in the blockchain, details of the transaction(s) that are to be included in the to-be-created block, and the nonce value to the CHF that may then be used to provide a hash value. If the hash value does not meet the threshold hash (e.g., the first four characters of the hash value are not each zero), the miner starts again to provide another hash value, thus increasing the amount of work. If the hash value meets the threshold hash (e.g., at least the first four characters of the hash value are each zero), the respective miner may have successfully created the next block that is to be added to the blockchain. Consequently, the respective miner's block is broadcast across the peer-to-peer network. All other miners cease work (because one miner was already successful), and all copies of the blockchain are updated across the peer-to-peer network to append the block to the blockchain. Each miner may produce hundreds of thousands (or more) of hash values, before any one miner provides a qualifying hash value (e.g., at least the first four characters of the hash value are each zero).

In some embodiments, the digital distributed ledger or blockchain system can include one or more sidechains. A sidechain may be described as a blockchain that validates data from other blockchains. In some examples, a sidechain may provide for granularity of information so that different information “types”, (e.g., equipment operation logs, field condition logs, meteorological conditions logs, and so on) may be stored in a different sidechain linked to a main chain. The blockchain may be a public blockchain, such that data stored on the blockchain is generally accessible to all. The blockchain or portions of the blockchain (e.g., certain blocks and/or certain sidechains) may alternatively or additionally be a private blockchain, such that the stored data is accessible only to authorized individuals and/or processes on the blockchain. The blockchain or portions of the blockchain may also include semipublic information, such as information to be provided to regulatory bodies (e.g., Occupational Safety and Health Administration (OSHA), Environmental Protection Act (EPA) authorities, General Data Protection Regulation (GDPR) authorities, and so on). Further, the blockchain may also include semiprivate information, such as information accessible to a farming cooperative, owner groups (e.g., ownership-by-share groups), and the like. By providing for authenticated, information, and/or associated transactions via blockchains, as further described below, enhanced transactional efficiencies, security, and information flows may be provided.

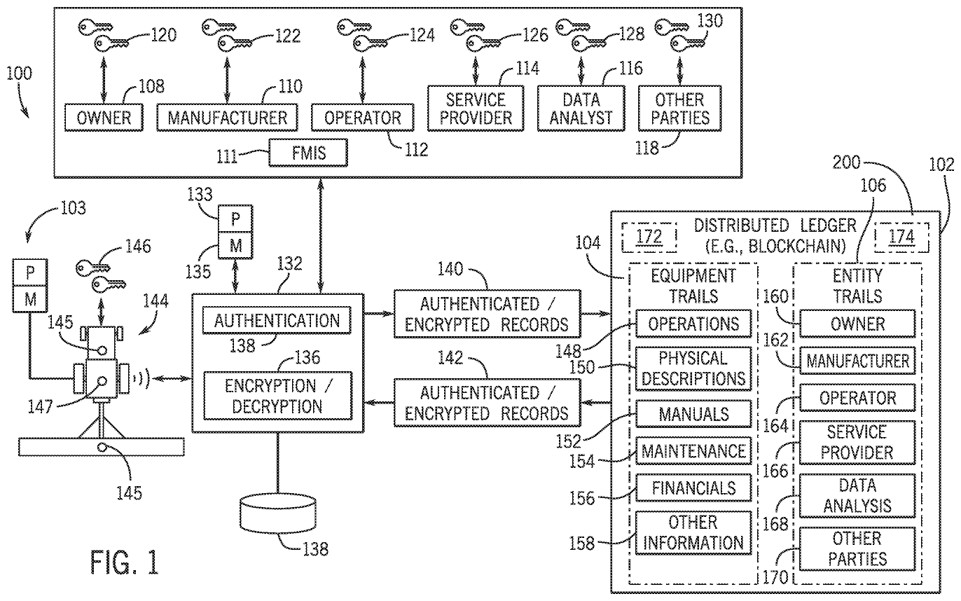

FIG. 1 depicts an embodiment of an equipment digital distributed ledger-based system 100 for equipment trail and entity trail creation and tracking, according to aspects of the present disclosure. As shown in the example of FIG. 1, the equipment digital distributed ledger-based system 100 includes a digital distributed ledger system 102 that may include one or more blockchains. The digital distributed ledger system 102 may be hosted on any suitable number of computing devices that operate as nodes for the digital distributed ledger system 102. Such nodes may be geographically distributed in any suitable number of locations. In some embodiments, the nodes may include computing devices disposed in equipment 144, such as in navigation units, engine control units (ECUs) 103, laptops (e.g., inside of vehicle cabs), notebooks, tablets, mobile phones, and so on, of the equipment 144.

The digital distributed ledger system 102 may store any appropriate number of data records of various types, including equipment trail records 104 and/or entity trail records 106. The equipment trail records 104 may include information related to equipment (e.g., farming equipment), while the entity trail records 106 may include information related to entities associated with the equipment. For example, entities may include owner(s) 108 of the equipment, manufacturer(s) 110 of the equipment, operator(s) 112 of the equipment, equipment service providers 114, data analysts 116, and other parties 118 (e.g., regulatory bodies, financial entities, equipment dealers, equipment brokers, equipment inspectors, insurance providers, governmental agencies). Each of the entities 108, 110, 112, 114, 116, 118 may include entity authentication and/or verification information that identifies a particular entity, such as an individual, a corporation, a club, and so on, participating in digital distributed ledger 102. For example, unique identification, such as cryptographic key(s) and/or IDs 120, 122, 124, 126, 128, 130, certificates of trust, government identification (e.g., operator licenses, driver's license, passport) and the like, may be used to uniquely identify parties involved in the digital distributed ledger 102.

In certain embodiments, the keys 120-130 may be a public/private key pair suitable for public/private key cryptography and/or authentication. In these embodiments, a public key owned by party A may be transmitted through open channels to party B. Party B may use their private key and the public key of party A to encrypt certain data, which may then be transmitted through open channels to party A. Party A may then receive the encrypted data, and use their private key to decrypt the data. Example public/private key pair systems include pretty good privacy (PGP), Gnu Privacy Guard (GPG), Diffie-Hellman key exchanges, Station-to-Station (STS) protocol, password-authenticated key (PK) agreement, and so on. In the depicted embodiment, an authentication/cryptography system 132 may be used to provide for authentication services 134 and/or encryption/decryption services 136. The authentication/cryptography system 132 may be implemented as computer code or instructions executable via one or more processors 133 of the system 100 and stored in a memory 135. The authentication/cryptography system 132 may also include or be operatively coupled to a storage (e.g., secure storage) system 138 used to store keys, certificates of trust, and other secure data.

In use the entities 108-118 may log into the authentication/cryptography system 132 to enter and/or to retrieve information stored in the digital distributed ledger 102. For example, two-factor authentication may be used to log into the authentication/cryptography system 132, and communications may include secure communications such as secure shell (SSH) protocol, transport layer security (TLS), hypertext transfer protocol secure (HTTPS), internet protocol security (IPsec), and the like. Accordingly, the entities 108-118 may input information 140 into the digital distributed ledger 102 and read information 142 from the digital distributed ledger 102. In some cases, data may be stored unencrypted in the digital distributed ledger 102, for example, data for public consumption.

In use, equipment 144 may also utilize the digital distributed ledger 102. For example, the equipment 144 may include multiple sensors 145 to provide for data such as engine revolutions per minute (RPM), equipment temperature(s), equipment pressures, fuel levels, liquid flows (e.g., coolant flows, fuel flows), electric battery levels, alarms, alerts, and so on. Accordingly, the equipment 144 may include keys 146 (e.g., public/private keys) suitable for accessing the authentication/cryptography system 132 to enter and/or to retrieve information stored in the digital distributed ledger 102. For example, a communications system 147 that may use WiFi, mesh networks, cellular networks, and so on, may be used to communicate between the equipment 144 and the authentication/cryptography system 132. In some cases, the equipment 144 may be stationary, so wired networks (e.g., internet networks, Foundation Fieldbus networks, industrial protocol networks, and so on) may be used to communicate between the equipment 144 and the authentication/cryptography system 132. It is to be noted that while the techniques herein are described in terms of farming equipment, any industrial equipment may benefit, including electric generators, power equipment, construction equipment, aviation equipment, and so on.

As the equipment operates, equipment logs may be stored as operations records 148 in the digital distributed ledger 102. As mentioned earlier, operations data such as seed type, seed deposition rates, soil type, soil humidity, soil pH, soil temperature, weather data (e.g., humidity, air temperature, wind speed, wind direction, solar radiation, sun exposure), vehicle speed, vehicle direction, vehicle position (e.g., latitude, longitude), vehicle orientation (e.g., driving forward, driving backward), fuel use, and so on, may be stored in the digital distributed ledger 102 via the operations records 148 (e.g., in one or more blockchain blocks). The records 148 may additionally store harvesting records, such as equipment 144 used (e.g., type of harvester and/or related equipment such as a towed harvesting system), type of crop, harvest rates, yields, harvester speed, harvester direction, harvester position (e.g., latitude, longitude), harvester orientation (e.g., driving forward, driving backward), fuel use, and so on. Operations data may also include data sensed via sensors, such as engine revolutions per minute (RPM), equipment temperature(s), equipment pressures, fuel levels, liquid flows (e.g., coolant flows, fuel flows), electric battery levels, alarms, alerts, and so on, stored in the records 148.

During planting, spraying, and/or fertilizer applications, the operations records 148 may include field inputs and field prescriptions such as what was applied (e.g., seed genetics, fertilizer, insecticides, pesticides, manure, and so on), when it was applied (date, time, or a combination thereof), application conditions (e.g., weather: wind speed/direction, precipitation, relative humidity, ambient pressure, temperature); application rates (e.g., gallons per acre, pounds per acre, and so on). The records 148 may also include, at what ground speed, pressures, flows throughout the field, and so on, where the planting, spraying, and/or fertilizer applications performed, slopes (e.g., sections of field, route taken) used in the applications, and/or how close the applications where, for example, to sensitive landscapes such as roads, parks, surface waterbodies, residential areas, and so on.

A physical description of the equipment, including manufacturing details, may also be stored in records 150. For example, the manufacturer 110 may enter into the records 150 the equipment model number, a description of the equipment, as well as manufacturing provenance such as where the equipment (and/or equipment parts) was made, date of manufacture, process involved, (e.g., additive manufacturing, milling, assembly processes, etc.), materials used, and so on. Records 152 may be used to store equipment manuals. For example, operator's manuals, maintenance manuals, and so on, may be stored in the records 152. As new manuals are created or the manuals updated, the new manuals and/or the updates may also be stored in records 152.

Maintenance information may be stored in records 154. For example, a service provider 114, such as a mechanic or a service shop, may log into the digital distributed ledger via the authentication/cryptography system 132 and enter maintenance events, such as repairs, fluid changes (e.g., oil changes, transmission fluid changes, differential fluid changes), tire rotations, upgrades (e.g., suspension upgrades, ECU flashing upgrades), parts replacements, and so on. In some embodiments, financial information related to the equipment 144 may also be stored. For example, records 156 may store information such as purchase price paid for the equipment by the owner 108, loan information, insurance information, return on investment information (e.g., monies collected by using the equipment taking into account equipment price, depreciation, and the like), tax information for the equipment, and so on. Other information may include operator 112 information such as operator licenses (e.g., license to use or to drive the equipment 144), regulatory data (e.g., emissions tests, equipment inspections, and so on), reports/analysis entered by the data analyst(s) 116, and other data entered by entities 108-118.

It is to be understood that data entered into records (e.g., blockchain blocks) 148-158 may be authenticated by the authentication/cryptography system 132 as being entered by one or more of the entities 108-118 and the data may be stored in the records 148-158 as encrypted. For example, each records 148-158 in a blockchain may include an ID of the entity or entities 108-118 that provided the data in the records and the ID of the equipment 144 that the data belongs to. Because the digital distributed ledger system 102 provides for immutable and traceable storage, the records 148-158 may provide for a secure, reliable, and distributed storage of the data associated with the equipment 144. Entity trail 106 may similarly store records 160-172. For example, records 160 may store ownership information, include owner name(s), addresses, deed records, fractional ownership records (e.g., shares owned and by whom), tax IDs, and the like. Records 162 may store manufacturer data, such as company name, division, address, agent of record, and so on. Records 164 may store operator data, such as company name (when operator is a company or a cooperative), individual name(s) (when operators include individuals), addresses, operator licensing information (e.g., equipment certification licenses, driver's licenses, permits to operate in certain jurisdictions), and so on. Records 166 may be used to store service provider information. For example, service providers may include mechanics providing maintenance services, meteorological entities providing meteorological data services, financial entities providing financial services (e.g., loans, banking services, brokerage services), consulting entities providing consulting services (e.g., field utilization services for farming), and the like. Accordingly, names, addresses, and/or identification information may be stored for each service provider in records 166.

Records 168 may store information related to data analysts, for example data analysts that have been vetted to work with the data in records 148, 150, 152, 154, 156, and/or 158. Data analyst information may include name, address, certifications, area(s) of expertise, and so on, for the data analyst or data analysis company. Records 170 may store information for other parties that participate in the system 100. For example, governmental agency information (e.g., U.S. Department of Agriculture (USDA), farm service agency (FSA), farm credit administration (FCA), environmental protection agency (EPA), local governments, state governments, federal governments), and the like, may be stored in records 170. Other parties may also include entities, including private entities, that may be authorized access to certain data in records 148, 150, 152, 154, 156, and/or 158, for example, for a fee. These buyers of data may use the information, as vetted by the information owners, for commercial purposes for example.

It is to be noted that the records 148-170 may be interrelated. For example, the operations records 148 may include information (e.g., unique ID) pointing to an operator in records 164 to link the operator 112 to certain operations data or logs. Likewise, the physical description records 150 and the manual(s) records 154 may include information (e.g., unique ID) pointing to one or more manufacturer(s) 110 whose information is stored in record(s) 162. Similarly, maintenance records 154 may include information (e.g., unique ID) pointing to one or more service providers 114 whose information may be stored in records 166. Financial records and/or other information records 158 may also include information (e.g., unique ID) pointing to one or more entities 108-118 whose information is stored in records 160-170. It is also to be noted that the records 148-158, and in some cases, the records 160-170, may store information (e.g., unique ID such as a VIN) identifying specific equipment 144. By interrelating information (e.g., many-to-many relationships between records 148-170 and equipment 144), traceability of information may be more easily provided.

By providing for the records stored in the trails 104, 106, the system 100 may enable governing bodies and regulatory agencies to receive a “raw” view of field (e.g., agricultural field, construction field) activities for compliance purposes. Instead of “averages” or “estimates”, unbiased actuals may be queried as posted in a public area of the distributed ledger system 102. Because of the immutable nature of distributed ledger system 102 combined with verifiable authentication information of data sources into the distributed ledger system 102, the distributed ledger system 102 may now provide irrefutable documentation to prove compliance and/or defend against litigation. Additionally, high speed reporting and inspections by regulatory agencies may now be more feasible due to executing queries against information stored in the trails 104, 106 from one or more sources (e.g., distributed storage of immutable information). Further, a manufacturer of machinery, such as CNH Industrial N.V., of Amsterdam, the Netherlands, could provide secure/trusted access to a cloud ecosystem that may satisfy the demands listed above, e.g., for regulatory compliance, evidence, and/or high speed reporting

In some embodiments, the digital distributed ledger system 102 may include a main blockchain 200 and one or more sidechains 172, 174 that may be linked to the main blockchain 200. In some embodiments, the sidechain 172 may be used to store certain record types. For example, an equipment trails sidechain 172 may store only equipment trail records 104. Likewise, an entity trails sidechain 174 may store only entity trail records 106. By using sidechains 172, 174 dedicated to specific trail types 104, 106, the techniques described herein may enable a more efficient record allocation in the digital distributed ledger 102. Further, in some embodiments, a side chain may be managed by various entities, for example, side chains 172 may be managed by multiple parties, such as equipment owners 108 and manufacturers 110, while the side chains 172 may be managed by entities 108-118. Likewise, the authentication/cryptography system 132 may be provided by the manufacturer 110, for example, as a cloud-based portal, while the digital distributed ledger 102 may be created initially by the manufacturer 110 but then grown by all participants in the system 100, e.g., entities 108-118 and/or equipment 144. A farm management information systems (FMIS) 111 is also shown, which may be communicatively and/or operatively coupled to the distributed ledger 102 and to the equipment 144. The FMIS 111 may be a platform system providing data to and from the vehicle 144, as well as users of the vehicle 144. For example, the FMIS 111 may provide for farming operations support and may be available from CNH Industrial N.V., of Amsterdam, the Netherlands.

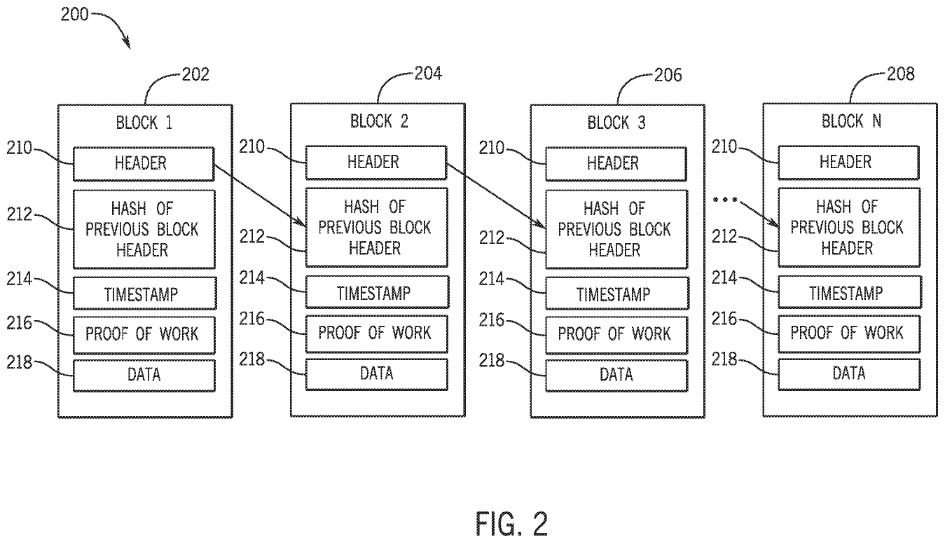

FIG. 2 is a diagram depicting an embodiment of the blockchain 200. In the depicted embodiment, the blockchain 200 is illustrated as having multiple blocks 202, 204, 206, and 208. The block 202 (first block in the blockchain 200) may have been created, for example, and allocated as a special starting block. The block 202 may include a unique header 210 uniquely identifying the block 202 from other blocks in the blockchain 200. Because the block 202 is the first block in the blockchain 200, a hash of a previous block header 212 may be set to zero. A timestamp 214 may include the date of creation for the block 202, and a proof of work section 216 may include certain “work” that proves that a “miner” has performed work suitable for the creation of the block 202 and/or to verify transactions in the blockchain 200. The work section 216 may vary based on a protocol used to create the blockchain 200. For example, a bitcoin protocol may use a Merkle tree. The Merkle tree may be a tree data structure in which every leaf node is labelled with a hash (e.g., one-way hash) of a data block and every non-leaf node is labelled with a cryptographic hash of the labels of its child nodes. Because of the one-way transformation used in hashing, the Merkle tree has the property that there is no known technique that a deceptive party could use to guess a value that would hash with a second-to-last value to create the Merkle root, which is know from our verified blockchain 200, and so on, down the tree. In other words, there's no way to create a fake value that would hash to our expected Merkle tree value (e.g., value stored in section 216 of the block 202), thus creating a single value that proves the integrity of all of the transactions under it.

Data, such as records included in the trails 104, 106, may be stored in a section 218 (and/or in another section). In certain embodiments, a new block may be created when a new record 148-170 is to be created. For example, an operations records 148 may result in the creation of a new block in the blockchain, which may be tied in via block ID to existing block(s). In another embodiment, empty blocks may be first created and then assigned to new blocks for the trails 104, 106 as new information comes in. When a new block is created, the block will receive a new header 210 uniquely identifying the new block. As mentioned earlier, a peer-to-peer network may include multiple “miners” (e.g., computing devices used by entities 108-118 and/or by the equipment 144) that add blocks to the blockchain 200 based on the blockchain protocol. In general, multiple miners validate transactions or data 218 that are to be added to a block, and compete (e.g., perform computing work, as introduced above) to have their respective block added to the blockchain 200. Validation of transactions and/or data includes verifying digital signatures associated with respective transactions and/or data 218. For a block to be added to the blockchain 200, a miner must demonstrate a proof of work before their proposed block of transactions is accepted by the peer-to-peer network, and before the block is added to the blockchain 200. In certain embodiments, a blockchain protocol include a proof of work scheme (e.g., Merkle Tree) that is based on a cryptographic hash function (CHF). An example CHF includes the secure hash algorithm 256 (SHA-256). In general, the CHF receives information as input, and provides a hash value as output, the hash value being of a predetermined length. For example, SHA-256 outputs a 256-bit (32-byte, 64-character) hash value. In some examples, the hash value is a one-way hash value such that the output hash value cannot be ‘un-hashed’ to determine what the input was. The blockchain protocol can require multiple pieces of information as input to the CHF. For example, the input to the CHF can include a reference to the previous (most recent) block (e.g., hash 212) in the blockchain 200, details of the transaction(s) or data 218 that are to be included in the to be created block, and a “nonce” value (e.g., a random number used only once).

Multiple nodes may compete to hash a set of transactions and to provide the next block that is to be added to the blockchain 200. The blockchain protocol may provides a threshold hash to qualify a block to be added to the blockchain 200. For example, the threshold hash can include a predefined number of zeros (0's) that the hash value must have at the beginning (e.g., at least the first four characters of the hash value must each be zero). The higher the number of zeros, the more computationally time-consuming it may be to arrive at a qualifying hash value.

In accordance with the blockchain protocol, each miner in the peer-to-peer network receives transaction information for one or more transactions that are to be included in a block that is to be added next in the blockchain 200. Each miner provides the reference to the previous (most recent) block in the blockchain 200, details of the data or transaction(s) 218 that are to be included in the to-be-created block, and the nonce value to the CHF that may then be used to provide a hash value. If the hash value does not meet the threshold hash (e.g., the first four characters of the hash value are not each zero), the miner starts again to provide another hash value, thus increasing the amount of work. If the hash value meets the threshold hash (e.g., at least the first four characters of the hash value are each zero), the respective miner may have successfully created the next block that is to be added to the blockchain 200. Consequently, the respective miner's block is broadcast across the peer-to-peer network (e.g., all devices communicatively coupled to the system 100). All other miners cease work (because one miner was already successful), and all copies of the blockchain 200 are updated across the peer-to-peer network to append the block to the blockchain 200. Each miner may produce hundreds of thousands (or more) of hash values, before any one miner provides a qualifying hash value (e.g., at least the first four characters of the hash value are each zero).

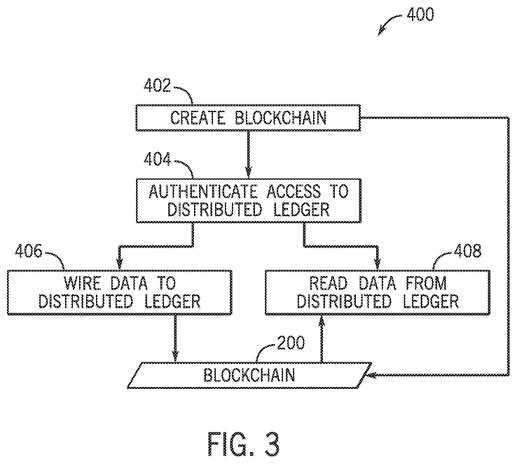

It is to be noted that any computing device, such as desktop computers, laptops, tables, mobile phones, other mobile devices, and so on, may be used for mining. Accordingly, as new information for the trails 104, 106 is created, new blocks may be added to the blockchain 200, including blocks 202, 204, 206, and 208. Indeed, the blockchain 200 may continue to grow, storing new records for information 148-170. Because of the distributed nature of the peer-to-peer network created via the digital distributed ledger-based system 100, each node (e.g., computing devices of the entities 108-118 and/or equipment 144) may include copies of the blockchain 200 and share copies of the blockchain 200 as new peers enter the peer-to-peer network. Each copy of the blockchain 200 may include authenticate and/or encrypted information (e.g., records for the trails 104, 106) for all or substantially all of the information tracked by the digital distributed ledger system 102. The information is immutable, and more efficiently tracked as new information gets added via the digital distributed ledger-based system 100. Accordingly, logs, relationships, transactions, or other information pertaining to the equipment 144 may be captured, as shown in FIG. 3.

FIG. 3 is a flowchart depicting an embodiment of a process 400 for the creation, storage, and queries of the trails 104, 106. The process 400 may be implemented as computer code or instructions executable, for example, by the processor(s) 133 and stored in the memory 135. In the depicted embodiment, the process 400 may create (block 402) a blockchain, such as the blockchain 200. For example, a first block 202 may be created, thus beginning the blockchain 200. The blockchain 200 may be created via the via the digital distributed ledger-based system 100, for example, and the blockchain 200 information used to access the blockchain 200 may be kept in a “wallet” stored in the storage 138.

As mentioned earlier, authentication/cryptography system 132 may be used to authenticate (block 402) access (e.g., read access, write access) to the blockchain 200. For example, after authentication (block 402), an entity 108-118 or the equipment 144 may write (block 406) data into the digital distributed ledger via the blockchain 200. In some embodiments, the data may be stored encrypted. As mentioned above, the data may include records stored in trails 104 and 106. For example, operations records 148, physical description records 150, manuals 152, maintenance records 154, financial records 156, and/or other records associated with the equipment 144 may be written (block 406) as encrypted data in the blockchain 200.

The data in the blockchain 200 may also be read (block 408), for example, via the authentication/cryptography system 132. That is, after authentication (block 404), the authentication/cryptography system 132 may retrieve desired blocks included in the blockchain 200 and convert the encrypted data into non-encrypted data viewable in a display. For example, data analysis may be executed to determine how to improve crop yields, how to improve planting in a specific field using the equipment 144, how to improve fuel efficiency with planting/harvesting, and so on. Likewise, ownership information may be verified, use of equipment and operator manuals may be improved, service provider data may be validated and used for further data analysis, and so on.

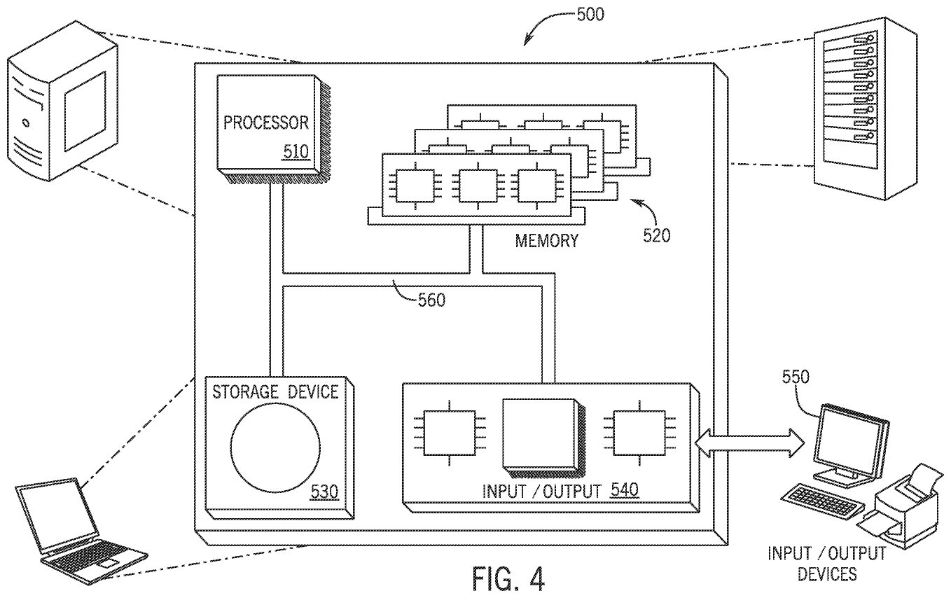

FIG. 4 depicts an example computing system, according to implementations of the present disclosure. The system 500 may be used for any of the operations described with respect to the various implementations discussed herein, For example, the system 500 may be included, at least in part, in the system 100, the node(s) that host the digital distributed ledger 102, and/or other computing device(s) or system(s) described herein. The system 500 may include one or more processors 510, a memory 520, one or more storage devices 530, and one or more input/output (I/O) devices 550 controllable via one or more I/O interfaces 540. The various components 510, 520, 530, 540, or 550 may be interconnected via at least one system bus 560, which may enable the transfer of data between the various modules and components of the system 500.

The processor(s) 510 may be configured to process instructions for execution within the system 500. The processor(s) 510 may include single-threaded processor(s), multi-threaded processor(s), or both. The processor(s) 510 may be configured to process instructions stored in the memory 520 or on the storage device(s) 530. For example, the processor(s) 510 may execute instructions for the various software module(s) described herein. The processor(s) 510 may include hardware-based processor(s) each including one or more cores. The processor(s) 510 may include general purpose processor(s), special purpose processor(s), or both.

The memory 520 may store information within the system 500. In some implementations, the memory 520 includes one or more computer-readable media. The memory 520 may include any number of volatile memory units, any number of non-volatile memory units, or both volatile and non-volatile memory units. The memory 520 may include read-only memory, random access memory, or both. In some examples, the memory 520 may be employed as active or physical memory by one or more executing software modules.

The storage device(s) 530 may be configured to provide (e.g., persistent) mass storage for the system 500. In some implementations, the storage device(s) 530 may include one or more computer-readable media. For example, the storage device(s) 530 may include a floppy disk device, a hard disk device, an optical disk device, or a tape device. The storage device(s) 530 may include read-only memory, random access memory, or both. The storage device(s) 530 may include one or more of an internal hard drive, an external hard drive, or a removable drive.

One or both of the memory 520 or the storage device(s) 530 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 500. In some implementations, the CRSM may include a data store that provides storage of computer-readable instructions or other information in a non-transitory format. The CRSM may be incorporated into the system 500 or may be external with respect to the system 500. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 510 and the memory 520 may be supplemented by, or incorporated into, one or more application-specific integrated circuits (ASICs).

The system 500 may include one or more I/O devices 550. The I/O device(s) 550 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 550 may also include one or more output devices such as a display, LED(s), an audio output device (e.g., a speaker), a printer, a haptic output device, and so forth. The I/O device(s) 550 may be physically incorporated in one or more computing devices of the system 500, or may be external with respect to one or more computing devices of the system 500.

The system 500 may include one or more I/O interfaces 540 to enable components or modules of the system 500 to control, interface with, or otherwise communicate with the I/O device(s) 550. The I/O interface(s) 540 may enable information to be transferred in or out of the system 500, or between components of the system 500, through serial communication, parallel communication, or other types of communication. For example, the I/O interface(s) 540 may comply with a version of the RS-232 standard for serial ports, or with a version of the IEEE 1284 standard for parallel ports. As another example, the I/O interface(s) 540 may be configured to provide a connection over Universal Serial Bus (USB) or Ethernet. In some examples, the I/O interface(s) 540 may be configured to provide a serial connection that is compliant with a version of the IEEE 1394 standard.

The I/O interface(s) 540 may also include one or more network interfaces that enable communications between computing devices in the system 500, or between the system 500 and other network-connected computing systems. The network interface(s) may include one or more network interface controllers (NICs) or other types of transceiver devices configured to send and receive communications over one or more communication networks using any network protocol.

Computing devices of the system 500 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 500 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code), such as one or more programs used to implement the process 400, may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

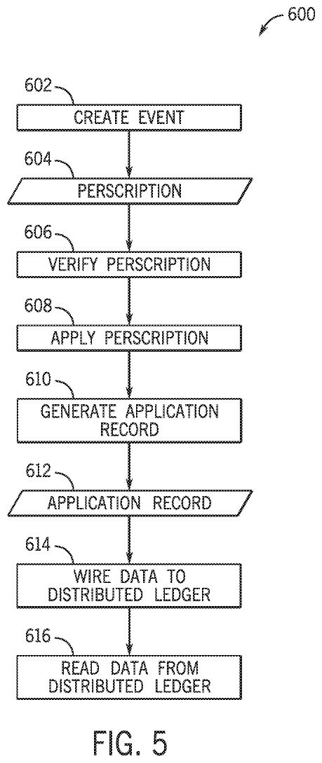

FIG. 5 is a block diagram of an embodiment of a process 600 that may be used to provide verifiable transactional data, for example, of planting, spraying, and/or fertilizer applications. In the depicted embodiment, the process 600 may first create (block 602) an event. The event may be a planting, spraying, and/or fertilizer event, which may be created, for example, using the Farm Management Information Systems (FMIS) 111, such as may be provided by the manufacturer 110, such as CNH Industrial N.V., of Amsterdam, the Netherlands, of certain equipment 144 (e.g., farming equipment). The event may be received by a FMIS platform network and sent to the vehicle 144. A cryptographic hash of the entire transaction event may be generated and digitally signed with the private key issued to the FMIS platform. This additional metadata (e.g., digital signature) is added to an event record to provide a prescription record 604. Once the vehicle 144 receives the event/prescription record 604, it may then verify (block 606) the record 604, for example by generating a cryptographic hash of the entire record 604 and using the public key of the FMIS 111 to verify that the event/prescription record 604 has not been modified or tampered in any manner along the way.

The operator, or if the vehicle 144 is autonomous, then vehicle and/or the operator, can apply (block 608) the verified prescription. For example, the field application of the prescription 604 may include a applying a certain type of seed genetics, seed amount, fertilizer, insecticides, pesticides, manure, and so on. Upon application (block 608), the process 600 may generate (block 610) a new application record 612, which may contain pertinent details including vehicle identity, field data, product data, weather conditions, type of seed genetics applied, seed amount applied, fertilizer applied, insecticides applied, pesticides applied, manure deposited, and so on, as well as when it was applied (date, time, or a combination thereof), application conditions (e.g., weather: wind speed/direction, precipitation, relative humidity, ambient pressure, temperature), application rates (e.g., gallons per acre, pounds per acre, and so on).

The application record 612 may then be hashed (e.g., a cryptographic hashing applied to the record 612), and the hash then written (block 614) into the distributed ledger 102. Data may then be read (block 616) from various entities (108-116) that access the distributed ledger 102. For example, public ledger registration may maintained for future data processing, searches, etc. This would allow any interested parties such as regulatory bodies, food processors, consumers, etc. to verify the prescription record 606 and/or resulting application record 612.

The techniques described herein may provide for tracking, for example, of repairs. For example, as right-to-repair regulations permit, equipment trails 104 may be used to track which repairs have been done (e.g., via maintenance records 154) in a verified manner. For example, entities (e.g., entities 120, 122, 124, 126, 128, 130) may log into the system when maintaining equipment associated with an equipment trail 104 and identify themselves as well as provide for maintenance description, part information (e.g., when replacing a part) and so on. Unverified repairs and/or parts may then be found, for example, by comparing the part found in the equipment against the equipment's verified parts list. Likewise, maintenance may be verified via maintenance logs found in the maintenance records 154.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A system comprising:
a digital distributed ledger-based system comprising a processor configured to:
authenticate a user of the digital distributed ledger-based system;
receive a prescription record from an external system, the prescription record comprising one or more field application instructions;
store the prescription record, a hash of the prescription record, or a combination thereof, in at least one or more blocks of a digital distributed ledger;
receive an operations data from the user, wherein the operations data comprises data logged during operations of an equipment while applying the prescription record;
store the operations data and identification information for the equipment, a hash of the operations data and/or the identification information, or a combination thereof, in the at least one or more blocks of the digital distributed ledger; and
distribute the one or more blocks among nodes of the digital distributed ledger, wherein the digital distributed ledger is configured to immutably store the operations data.

2. The system of claim 1, wherein the operations data comprises an applications record including type of seed applied, fertilizer applied, insecticide applied, pesticide applied, manure applied, application date, application time, application conditions, application rate, or a combination thereof.

3. The system of claim 1, wherein external system comprises a farm management information systems (FMIS) configured to create the prescription record.

4. The system of claim 1, wherein the digital distributed ledger-based system comprises an authentication/cryptography system executable by the processor and configured to authenticate the user and to store the operations data, including information identifying the user, as encrypted data in the at least one or more blocks.

5. The system of claim 4, wherein the authentication/cryptography system is configured to retrieve the encrypted data and to provide unencrypted data to the user for viewing on a display.

6. The system of claim 1, wherein the user comprises an equipment owner, an equipment operator, an equipment service provider, a data analyst, a governmental agency, a regulatory agency, or a combination thereof, and wherein the processor is configured to receive a maintenance data for the equipment, a financial data for the equipment, a data analysis report, an equipment certification, an operator certification, or a combination thereof, from the user, and to store the maintenance data, the financial data, the data analysis report, the equipment certification, the operator certification, or a combination thereof, in the at least one or more blocks of the digital distributed ledger with the identification information to identify that the maintenance data, the financial data, the data analysis report, the equipment certification, the operator certification, or the combination thereof, is associated with the equipment.

7. The system of claim 6, wherein the processor is configured to store identification information for the equipment owner, for the equipment operator, for the equipment service provider, for the data analyst, for the governmental agency, for the regulatory agency, or a combination thereof, in the at least one or more blocks of the digital distributed ledger.

8. The system of claim 1, wherein the processor is configured to store the at least one or more blocks in a sidechain of the digital distributed ledger.

9. The system of claim 1, wherein digital distributed ledger is configured to immutably store the data via a peer-to-peer network.

10. A method performed by at least one processor, the method comprising:
authenticating a user of a digital distributed ledger-based system;
receiving a prescription record from an external system, the prescription record comprising one or more field application instructions;
storing the prescription record, a hash of the prescription record, or a combination thereof, in at least one or more blocks of a digital distributed ledger;
receiving an operations data from the user, wherein the operations data comprises data logged during operations of an equipment to apply the field application instructions;
storing the operations data and identification information for the equipment, a hash of the operations data and/or the identification information, or a combination thereof in the at least one or more blocks of the digital distributed ledger; and
distributing the one or more blocks among nodes of the digital distributed ledger, wherein the digital distributed ledger is configured to immutably store the operations data.

11. The method of claim 10, wherein the user comprises an equipment system and wherein the operations data comprises an applications record including type of seed applied, fertilizer applied, insecticide applied, pesticide applied, manure applied, application date, application time, application conditions, application rate, or a combination thereof.

12. The method of claim 10, wherein external system comprises a farm management information systems (FMIS) configured to create the prescription record.

13. The method of claim 10, comprising authenticating, via an authentication/cryptography system, the user and storing the operations data, including information identifying the user, as encrypted data in the at least one or more blocks, and retrieving, via the authentication/cryptography system, the encrypted data and providing unencrypted data to the user for viewing on a display.

14. The method of claim 13, comprising receiving a maintenance data for the equipment, a financial data for the equipment, a data analysis report, an equipment certification, an operator certification, or a combination thereof, from the user, and storing the maintenance data, the financial data, the data analysis report, the equipment certification, the operator certification, or a combination thereof, in the at least one or more blocks of the digital distributed ledger with the identification information to identify that the maintenance data, the financial data, the data analysis report, the equipment certification, the operator certification, or the combination thereof, is associated with the equipment, wherein the user comprises an equipment owner, an equipment operator, an equipment service provider, a data analyst, a governmental agency, a regulatory agency, or a combination thereof.

15. The method of claim 14, comprising storing identification information for the equipment owner, for the equipment operator, for the equipment service provider, for the data analyst, for the governmental agency, for the regulatory agency, or a combination thereof, in the at least one or more blocks of the digital distributed ledger.

16. One or more non-transitory computer-readable storage media storing instructions which, when executed, cause at least one processor to perform operations comprising:
authenticating a user of a digital distributed ledger-based system;
receiving a prescription record from an external system, the prescription record comprising one or more field application instructions;
storing the prescription record, a hash of the prescription record, or a combination thereof, in at least one or more blocks of the digital distributed ledger;
receiving an operations data from the user, wherein the operations data comprises data logged during operations of an equipment to apply the field application instructions;
storing the operations data and identification information for the equipment, a hash of the operations data and/or the identification information, or a combination thereof, in the at least one or more blocks of the digital distributed ledger; and
distributing the one or more blocks among nodes of the digital distributed ledger, wherein the digital distributed ledger is configured to immutably store the operations data.

17. The one or more non-transitory computer-readable storage media of claim 16, wherein the operations data comprises an applications record including type of seed applied, fertilizer applied, insecticide applied, pesticide applied, manure applied, application date, application time, application conditions, application rate, or a combination thereof.

18. The one or more non-transitory computer-readable storage media of claim 16, wherein the instructions cause the processor to perform operations comprising authenticating, via an authentication/cryptography system, the user and storing the operations data, including information identifying the user, as encrypted data in the at least one or more blocks, and retrieving, via the authentication/cryptography system, the encrypted data and providing unencrypted data to the user for viewing on a display.

19. The one or more non-transitory computer-readable storage media of claim 16, wherein the instructions cause the processor to perform operations comprising receiving a maintenance data for the equipment, a financial data for the equipment, a data analysis report, an equipment certification, an operator certification, or a combination thereof, from the user, and storing the maintenance data, the financial data, the data analysis report, the equipment certification, the operator certification, or a combination thereof, in the at least one or more blocks of the digital distributed ledger with the identification information to identify that the maintenance data, the financial data, the data analysis report, the equipment certification, the operator certification, or the combination thereof, is associated with the equipment, wherein the user comprises an equipment owner, an equipment operator, an equipment service provider, a data analyst, a governmental agency, a regulatory agency, or a combination thereof.

20. The one or more non-transitory computer-readable storage media of claim 19, wherein the instructions cause the processor to perform operations comprising storing identification information for the equipment owner, for the equipment operator, for the equipment service provider, for the data analyst, for the governmental agency, for the regulatory agency, or a combination thereof, in the at least one or more blocks of the digital distributed ledger.
